(19) United States
(12) Patent Application Publication
(10) Pub. No.: US 2020/0001174 A1
(43) Pub. Date: Jan. 2, 2020

(54) ELECTRONIC GAMING TABLE

(71) Applicant: Jackpot Digital Inc., Vancouver (CA)

(72) Inventors: Jake Kalpakian, Vancouver (CA); Adam Fritz, Vancouver (CA); Robert Bell, Vancouver (CA); Tin-ming Ng, Vancouver (CA); Ben Silverstein, Vancouver (CA); Kelsey Armour, Vancouver (CA); Kati Kuo, Vancouver (CA); Yong Zhou, Vancouver (CA); Alejandro Guillen Juarez, Vancouver (CA); Dmitry Molochko, Vancouver (CA); David Fox, Vancouver (CA); Andrey Peshkov, Vancouver (CA); Srisha Kolachala, Vancouver (CA); Adam Chernoff, Vancouver (CA); Nicholas O'Bree, Vancouver (CA)

(21) Appl. No.: 16/486,478

(22) PCT Filed: Feb. 16, 2018
(86) PCT No.: PCT/CA2018/050186

§ 371 Date: Aug. 15, 2019

Related U.S. Application Data
(60) Provisional application No. 62/460,058, filed on Feb. 16, 2017.

(51) Int. Cl. A63F 13/2145; G07F 17/32

(52) U.S. Cl. CPC A63F 13/2145; G07F 17/3211; G07F 17/322

(57) ABSTRACT

An electronic gaming table comprises a base and a computer housed in the base. There is a table top mounted on the base. The table top has a frame, a monitor disposed within the frame, and a touch screen overlaying the monitor. The monitor receives game content from the computer and the monitor displays the game content. The monitor and the touch screen function together to provide a multi-touch playing surface for playing electronic games.

### TECHNICAL FIELD

The present disclosure relates to an electronic gaming table and, in particular, to an electronic gaming table for implementing casino games and other multiplayer games.

### BACKGROUND

U.S. Pat. No. 9,335,869, which issued to Mattice et al. on May 10, 2016, discloses a gaming system comprising a memory device, a microprocessor, and a composite touchscreen. The composite touchscreen comprises a display, an acoustic pulse recognition touchscreen subsystem, a capacitive touchscreen subsystem, and one or more touchscreen controllers. The touchscreen is configured to detect an x-y coordinate location of a touch upon the touchscreen with the acoustic pulse recognition subsystem and to detect a lift-off of an object with the capacitive touchscreen subsystem.

U.S. Pat. No. 7,341,519, which issued to McMain et al. on Mar. 11, 2008, discloses a system and method wherein a player of a casino game or an online casino game is provided one or more additional opportunities to place bets, or to consume information or content, or perform a variety of tasks, without the need to leave the casino game (or online casino game), and with minimal disruption of the casino game, thus potentially increasing the revenue to the casino.

### SUMMARY

It is an object of the present invention to provide an electronic gaming table having a single surface, multi-touch interface.

There is accordingly provided an electronic gaming table comprising a base and a computer housed in the base. There is a table top mounted on the base. The table top has a frame, a monitor disposed within the frame, and a touch screen overlaying the monitor. The monitor receives game content from the computer and the monitor displays the game content. The monitor and the touch screen function together to provide a multi-touch playing surface for playing electronic games.

The monitor and the touch screen may be separated by an air gap. The air gap may be up to 2.5 millimetres. The touch screen may include a first layer of glass, a second layer of glass, and a touch film disposed between the first layer of glass and the second layer of glass. The first layer of glass may have a thickness between 3 millimetres and 6 millimetres. The second layer of glass may have a thickness between 2 millimetres and 4 millimetres. At least one of the first layer of glass and the second layer of glass may be made of chemically strengthened glass. At least one of the first layer of glass and the second layer of glass may be made of tempered glass.

The electronic gaming table may include a modular platform which allows two multiplayer games to be simultaneously activated and played on the electronic gaming table. The electronic gaming table may also include embedded single player side games which operate simultaneously and independently of a multiplayer game being played on the electronic gaming table. The electronic gaming table may further include an edge rail which has a rounded rectangular shape. The edge rail may cover sharp corners of the monitor so as to create the appearance of a playing surface with rounded corners.

There is also provided a method of providing a multi-touch playing surface for playing a game on an electronic gaming table. The method comprises providing a monitor and a touch screen overlaid on top of the monitor. The monitor and the touch screen are separated by an air gap. The method further comprises identifying a cluster of multiple touch points on the touch screen simultaneously, registering the touch points, and translating the touch points into a single gesture.

The method may also include providing a single player side game which operates simultaneously and independently of a multiplayer game. The side game may be disabled during a player's turn in the multiplayer game. The method may further include activating a first multiplayer game on a first half of the playing surface, activating a second multiplayer game on a second half of the playing surface, and allowing the first multiplayer game and the second multiplayer game to be played simultaneously and independently of each other. The first multiplayer game and the second multiplayer game may be made different types of multiplayer games. Alternatively, the first multiplayer game and the second multiplayer game may be made the same type of multiplayer game.

### BRIEF DESCRIPTION OF THE DRAWINGS

FIG. 1 is a perspective view of an electronic gaming table shown with chairs;

FIG. 2 is a top perspective view of the electronic gaming table of FIG. 1;

FIG. 3 is a bottom perspective view of the electronic gaming table of FIG. 1;

FIG. 4 is a side elevational view of the electronic gaming table of FIG. 1;

FIG. 5 is an end elevational view of the electronic gaming table of FIG. 1;

FIG. 6 is an exploded, perspective view of the electronic gaming table of FIG. 1;

FIG. 7 is a perspective view of a base of the electronic gaming table of FIG. 1;

FIG. 8 is an exploded, perspective view of the base of FIG. 7;

FIG. 9 is another exploded, perspective view of the electronic gaming table of FIG. 1;

FIG. 10 is a perspective view of a frame of a table top of the electronic gaming table of FIG. 1;

FIG. 11 is an exploded, perspective view of the frame of FIG. 10;

FIG. 12 is an exploded, perspective view showing a monitor, a touch screen, and an edge rail of the table top of the electronic gaming table of FIG. 1;

FIG. 13 is a top plan view of the electronic gaming table of FIG. 1;

FIG. 14 is a fragmentary, cross-sectional view of the table top of the electronic gaming table of FIG. 1;

FIG. 15 is a cross-sectional view of the touch screen of the table top of the electronic gaming table of FIG. 1;

FIG. 16 is a perspective view showing a multi-touch gesture which may be implemented on the electronic gaming table of FIG. 1;

FIG. 17 is a top plan view of the electronic gaming table of FIG. 1 showing single player side games overlaid on top of a community game;

FIG. 18 is a plan view showing a single player side game of blackjack being played on the electronic gaming table of FIG. 1;

FIG. 19 is a plan view showing a single player side game of baccarat being played on the electronic gaming table of FIG. 1;

FIG. 20 is a top plan view showing player options for a community game of poker being played on the electronic gaming table of FIG. 1;

FIG. 21 is a perspective view of the electronic gaming table of FIG. 1 showing two simultaneous community games; and

FIG. 22 is a top plan view of the electronic gaming table of FIG. 1 showing an example of a seating arrangement.

### DESCRIPTION OF EMBODIMENTS

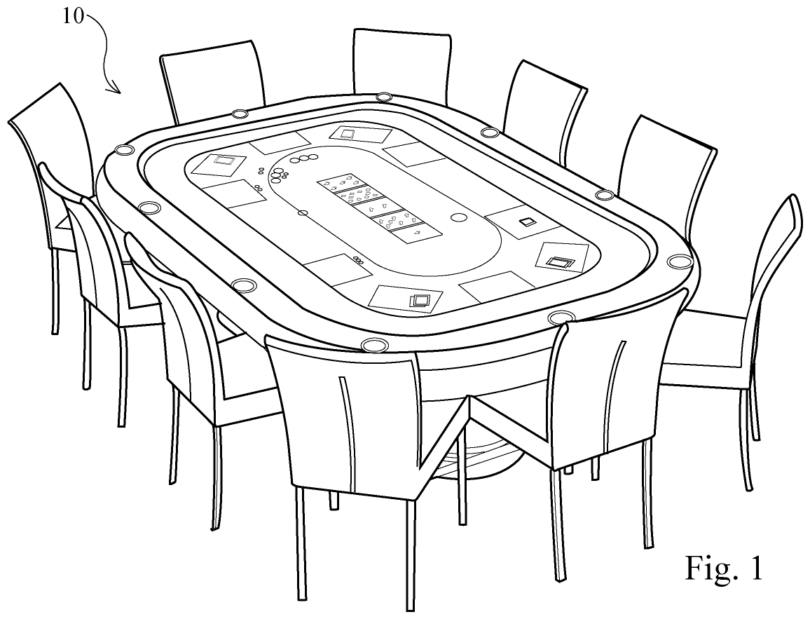

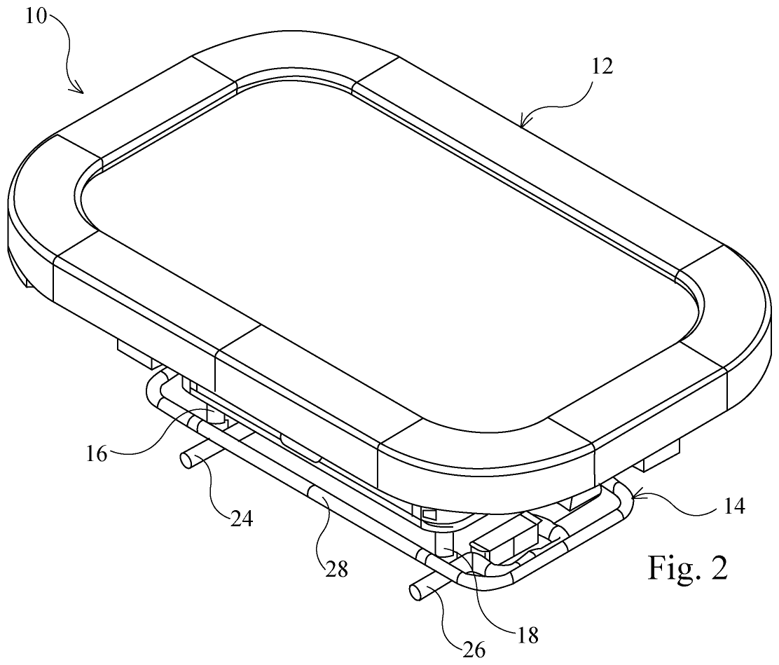

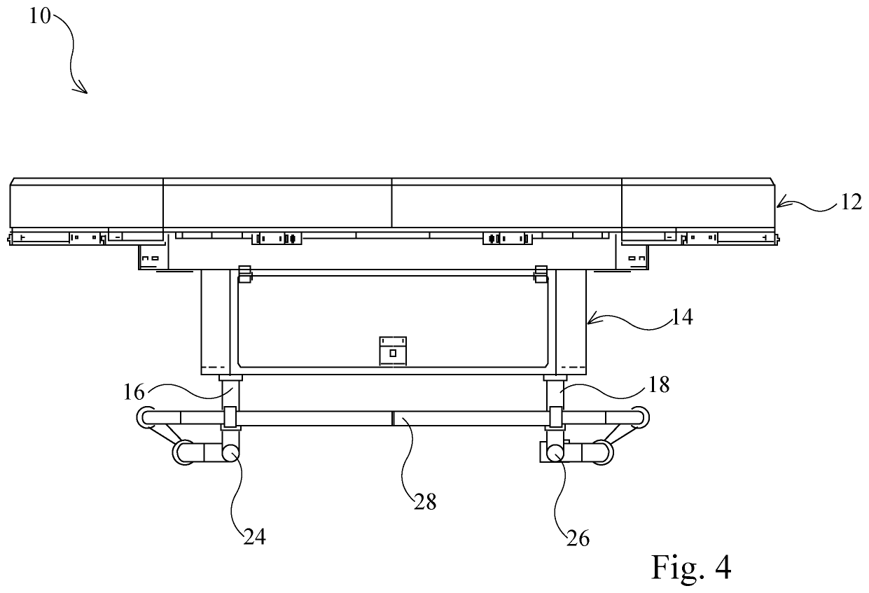

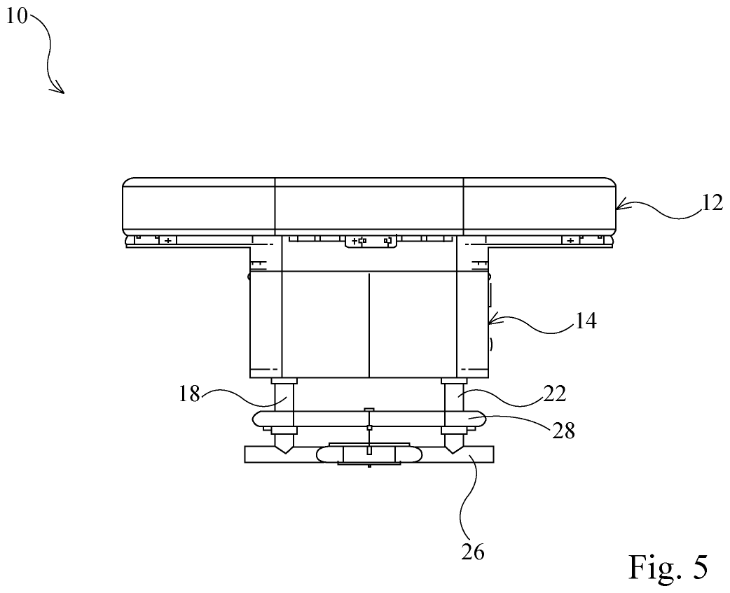

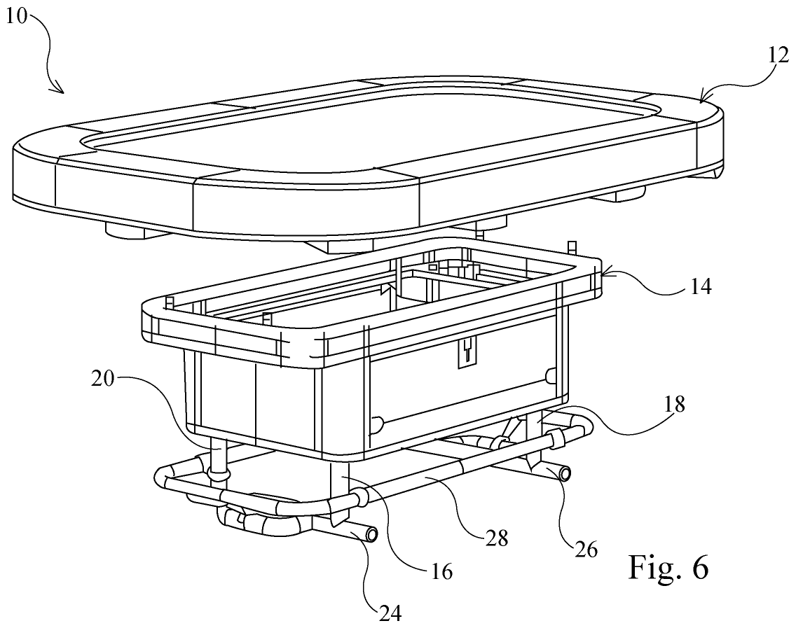

Referring to the drawings and first to FIG. 1, there is shown an electronic gaming table 10. As best shown in FIGS. 2 to 6, the electronic gaming table 10 includes a table top 12 and a base 14. The base 14 may be supported on a plurality of spaced-apart legs, for example, spaced-apart legs 16, 18, 20 and 22. The ends of the legs 16 and 20 may be connected by an elongated foot member 24 and the ends of the legs 18 and 22 may be connected by an elongated foot member 26. The foot members 24 and 26 may increase the stability of the legs 16, 18, 20 and 22. There may be a horizontal rail 28 extending about the legs 16, 18, 20 and 22 proximal to the foot members 24 and 26 to allow players to rest their feet during games. The horizontal rail 28 has rounded corners in this example. The height of the electronic gaming table 10 may be adjustable.

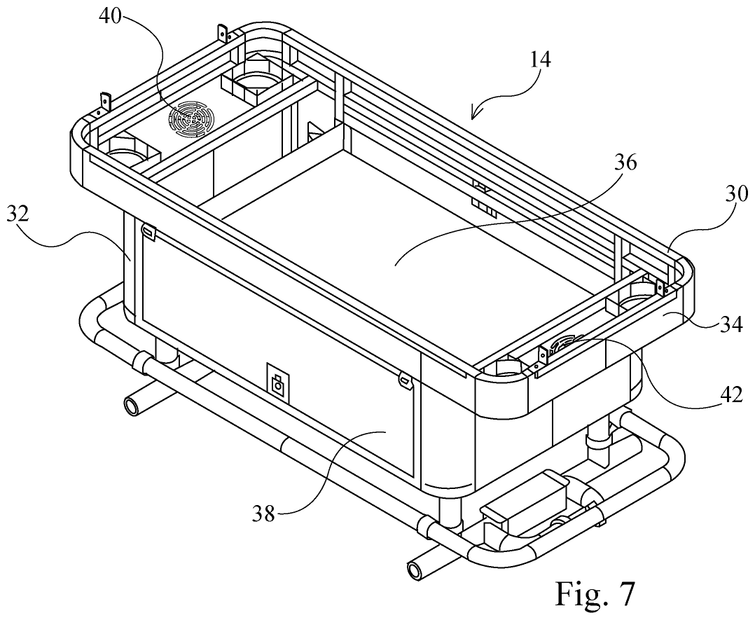

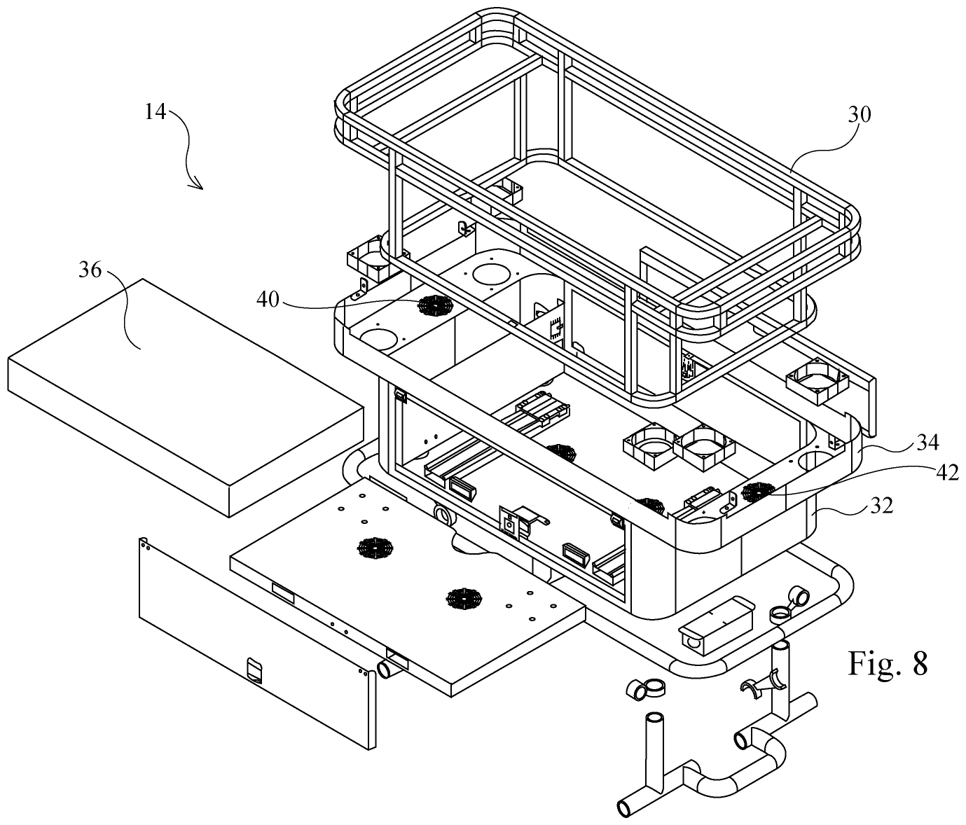

Referring now to FIGS. 7 and 8, the base 14 is shown in greater detail and includes a chassis 30 received within a housing 32. The housing 32 is generally rectangular in shape with a protruding rim portion 34 in this example. The housing 32 houses a computer 36 which includes a processor and memory for storing software. The computer 36 may be communicatively connected to a game server via a wired or wireless connection. There may be a drawer 38 to provide easy access to the computer 36 housed within the housing 32. The housing 32 may include a plurality of fans, for example, fans 40 and 42 to cool the computer 36. The housing 32 may also include one or more power supplies, an uninterruptable power supply, distribution circuit boards, and cabling.

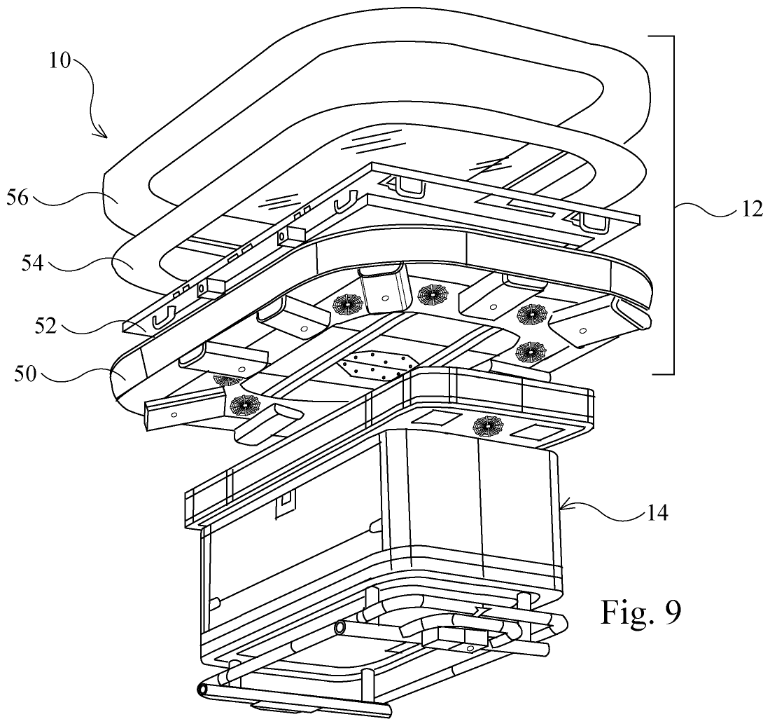

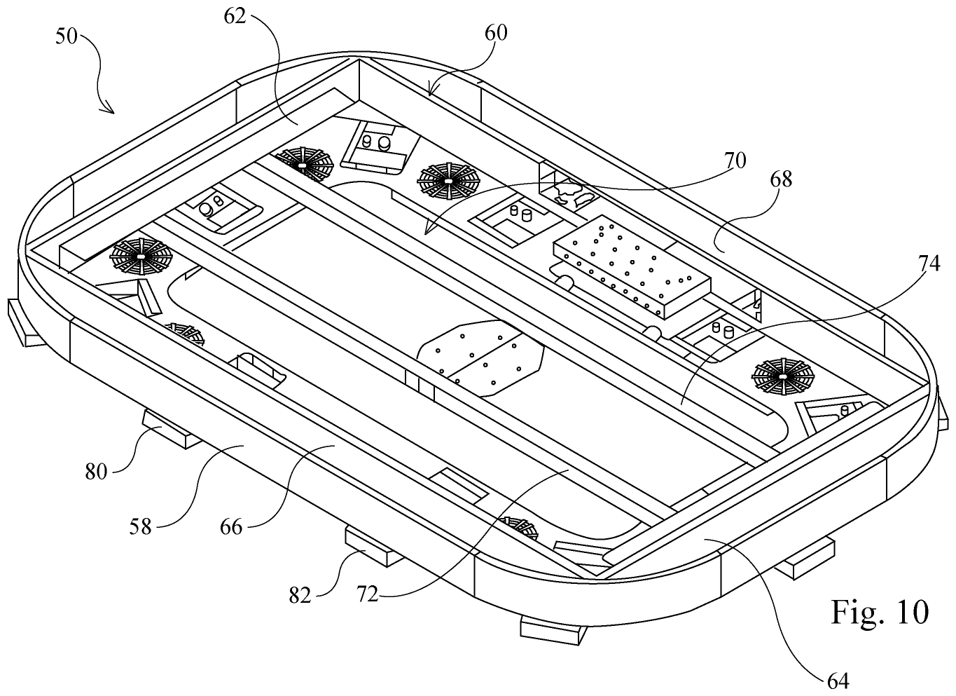

Referring now to FIG. 9, the table top 12 is shown in greater detail and includes a frame 50, a monitor 52 disposed within the frame 50, a touch screen 54 overlaying the monitor 52, and an edge rail 56 extending about the frame 50. The monitor 52 receives and displays game content. As best shown in FIG. 10, the frame 50 includes an outer wall 58 and an inner wall 60. In this example, the outer wall 58 has a rounded rectangular shape and the inner wall 60 has a rectangular shape. The inner wall 60 comprises end walls 62 and 64 and spaced-apart side walls 66 and 68 extending between the end walls 62 and 64. The end walls 62 and 64 and the side walls 66 and 68 together define a central cavity 70 of the frame 50. A pair of spaced-apart bars 72 and 74 extend between the end walls 62 and 64. The monitor 52, shown in FIG. 9, is received within the central cavity 70 and is supported by the bars 72 and 74.

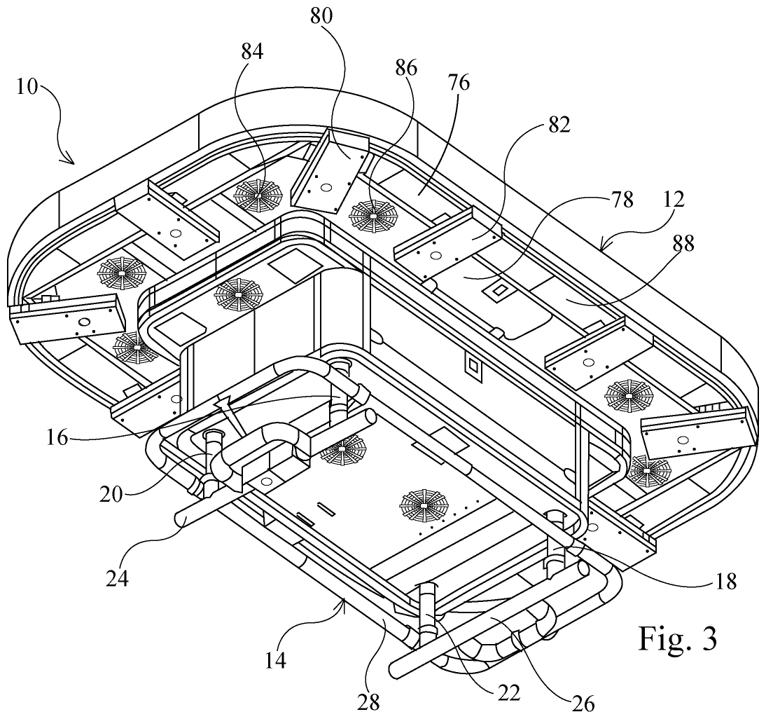

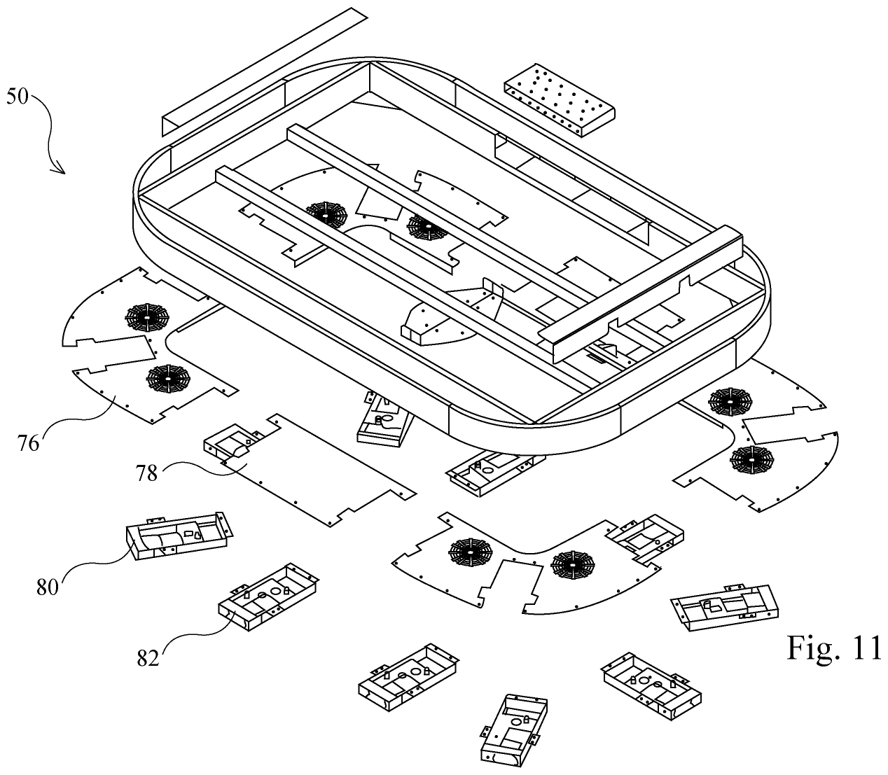

As best shown in FIG. 11, the frame 50 includes a plurality of individual bottom plates, for example, bottom plates 76 and 78. The frame 50 also includes a plurality of player station boxes, for example, player station boxes 80 and 82. The player station boxes are mounted to undersides of the bottom plates as shown by the player station boxes 80 and 82 which are mounted to undersides of the bottom plates 76 and 78, respectively, in FIG. 3. There may also be speakers, for example, speakers 84 and 86 provided on an underside 88 of the table top 12.

Each of the player station boxes may be provided with a card reader, such as a RFID card reader or a magnetic stripe card reader. Alternatively, or additionally, each of the player station boxes may be provided with other account reading devices such as an NFC tap reader or a fingerprint scanner. This allows players to store their player account so they can login and load funds. This may also allow players to store their player loyalty account so that player sessions are tracked and casino loyalty points are earned. Each of the player station boxes may also be provided with circuit boards and cabling such as USB cabling.

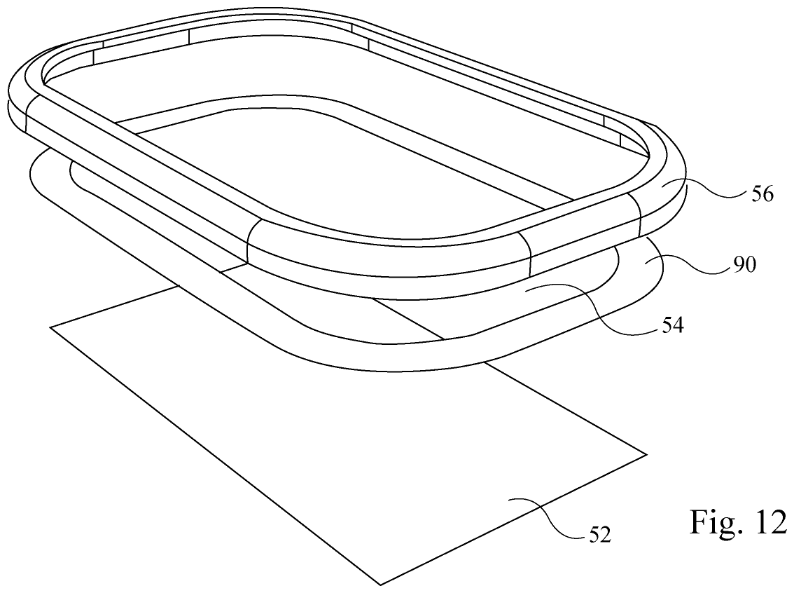

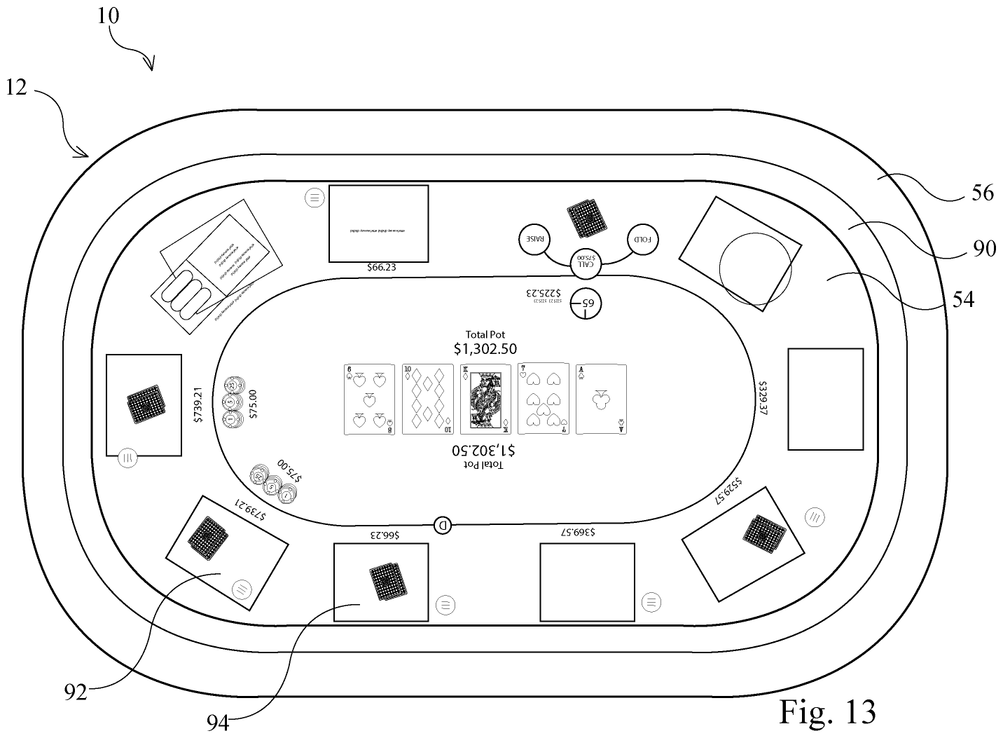

Referring now to FIG. 12, in this example, the monitor 52 has a rectangular shape while the touch screen 54 and the edge rail 56 each have a rounded rectangular shape. The touch screen 54 also includes a border 90 in this example. When the table top 12 is assembled, the edge rail 56 covers the sharp corners of the rectangular monitor 52 to create the appearance of a rounded playing surface as shown in FIG. 13. The border 90 of the touch screen 54 also functions to cover up the corners of the monitor 52 and to enhance the appearance of the electronic gaming table 10. The monitor 52 and the touch screen 54 function together to provide a single surface, multi-touch interface for playing electronic games. The touch screen 54 may include individual player activated areas, for example, player activated areas 92 and 94.

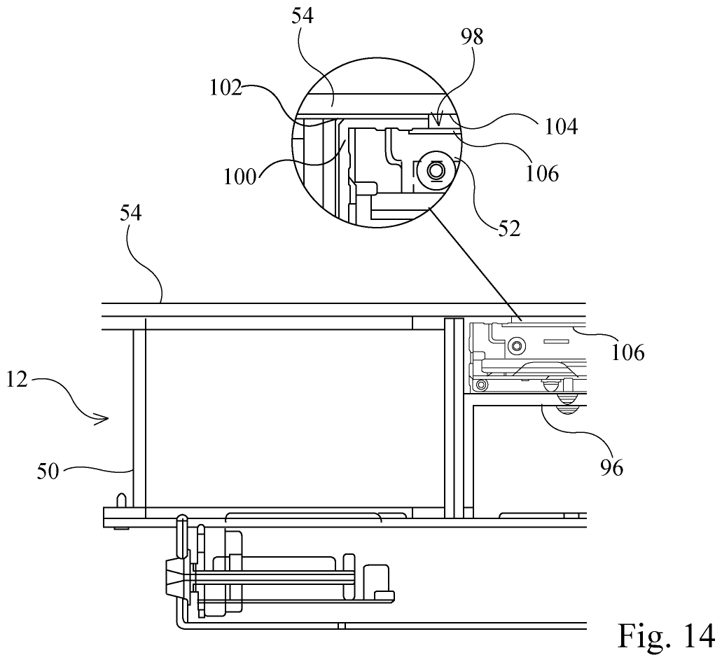

FIG. 14 is a cross-sectional view of the assembled table top 12. The monitor 52 is received by the frame 50 and is supported on a monitor mount 96. The touch screen 54 is separated from the monitor 52 by an air gap 98. The air gap 98 is created by a bezel 100 of the monitor 52 and a gasket 102 which separate a bottom 104 of the touch screen 54 from a top surface 106 of the monitor 52. The air gap 98 may be up to 2.5 millimetres in height. A smaller air gap between the touch screen 54 and the monitor 52 is advantageous because it reduces the likelihood of a player's cards displayed on the monitor being seen underneath the touch screen by other players when the cards are being covered by the player's hands.

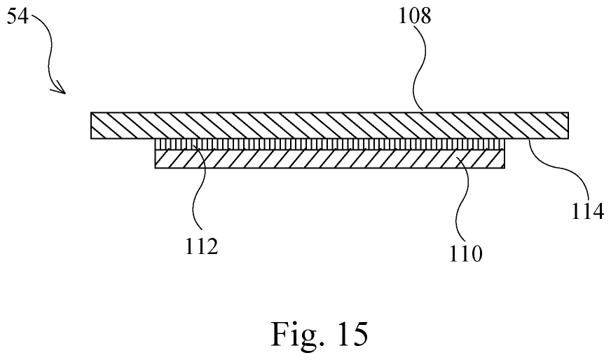

The small size of the air gap 98 is made possible by the configuration of the touch screen 54 which is best shown in FIG. 15. In particular, the touch screen 54 includes a top glass layer 108, a bottom glass layer 110 and a touch film 112 disposed between the top glass layer 108 and the bottom glass layer 110. The top glass layer 108 may have a thickness between 3 millimetres and 6 millimetres. The bottom glass layer 110 may have a thickness between 2 millimetres and 4 millimetres. The top glass layer and the bottom glass layer may each be chemically strengthened glass, tempered glass, or untreated glass. The border 90 of the touch screen 54, shown in FIG. 12, is screen printed onto a bottom 114 of the top glass layer 108 in this example.

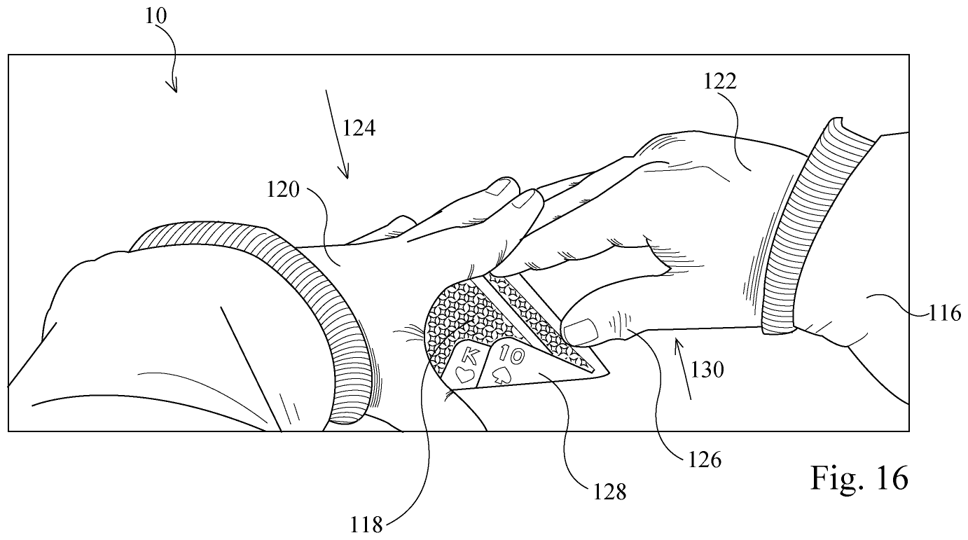

The single surface, multi-touch interface of the electronic gaming table 10 works by identifying a cluster of multiple touch points simultaneously, registering the touch points, and translating the touch points into a single action or gesture. In particular, game software loaded onto the computer 36 takes touch feedback from the touch screen 54 and recognizes touch points in certain places on the player activated areas 92 and 94. This allows players to use their entire palms, instead of just their fingertips, to play games on the electronic gaming table 10. FIG. 16 shows an example of a multi-touch gesture which may be performed on the electronic gaming table 10. A player 116 cups theirs hands 120 and 122 across their playing cards 118. The player 116 then slides their hands 120 and 122 downwardly in the direction indicated by arrow 124 while using one of their thumbs 126 to slide corners 128 of the cards 118 upwardly in the direction indicated by arrow 130. The corners 128 of the cards 118 then peel back to reveal the cards. This multi-touch gesture provides players with a more realistic gaming experience which resembles playing with physical playing cards. Alternatively, the player 116 may view their cards by first cupping their hands 120 and 122 across the cards 118 and then tapping on the corners 128 of the cards 118. The corners 128 of the cards 118 then peel back to reveal the cards.

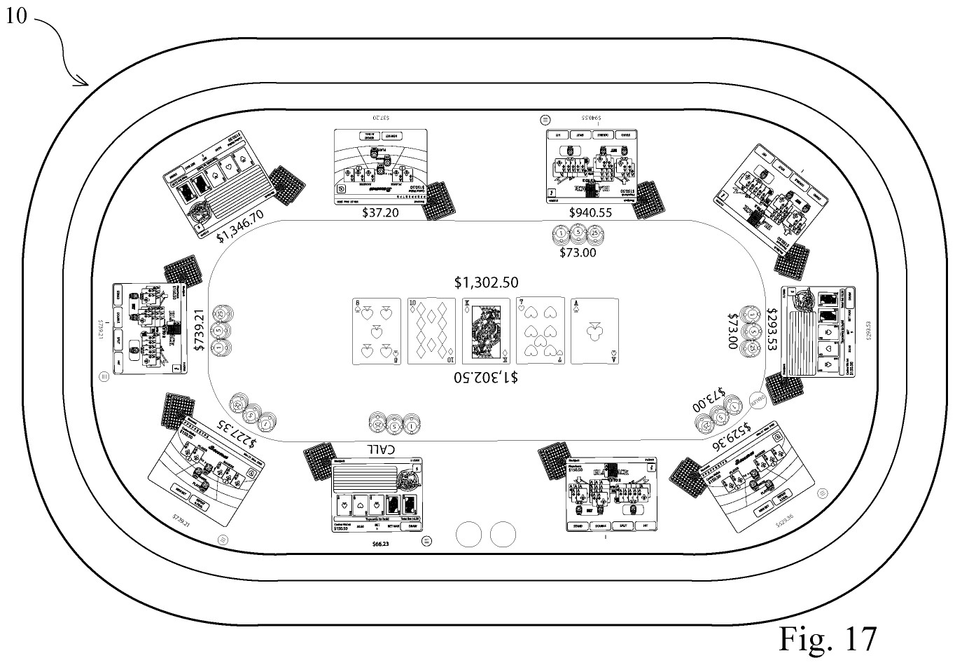

FIG. 13 shows a community (multiplayer) game being played on the electronic gaming table 10 which, in this example, is a community poker game. However, the electronic gaming table 10 may also be provided with embedded single player mini or side games which operate at the same time as the community game as shown in FIG. 17.

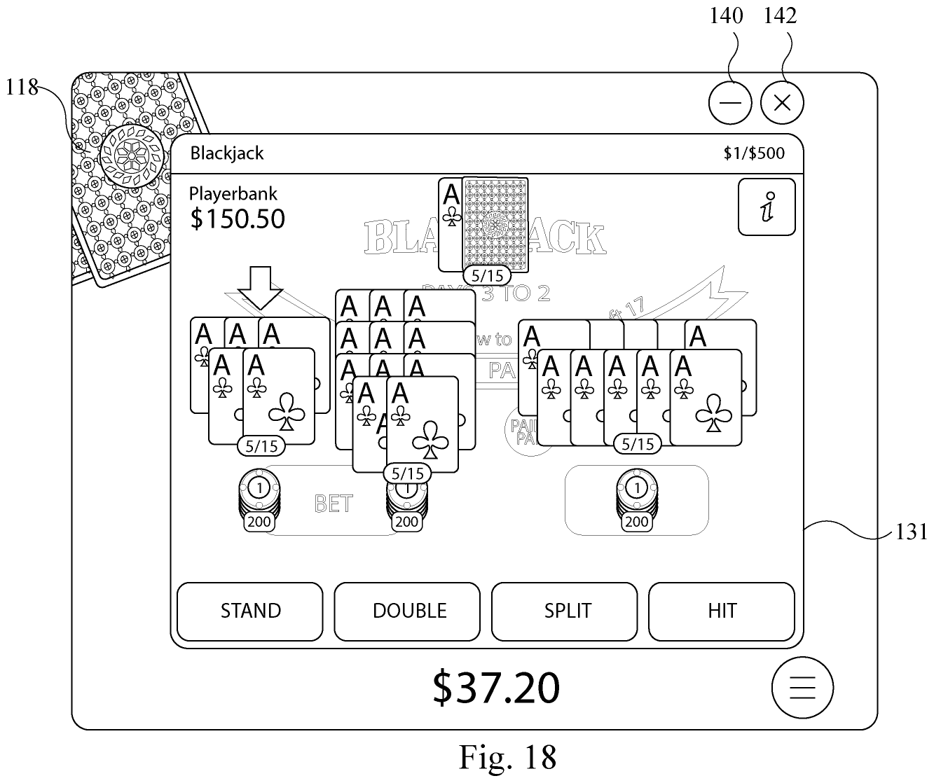

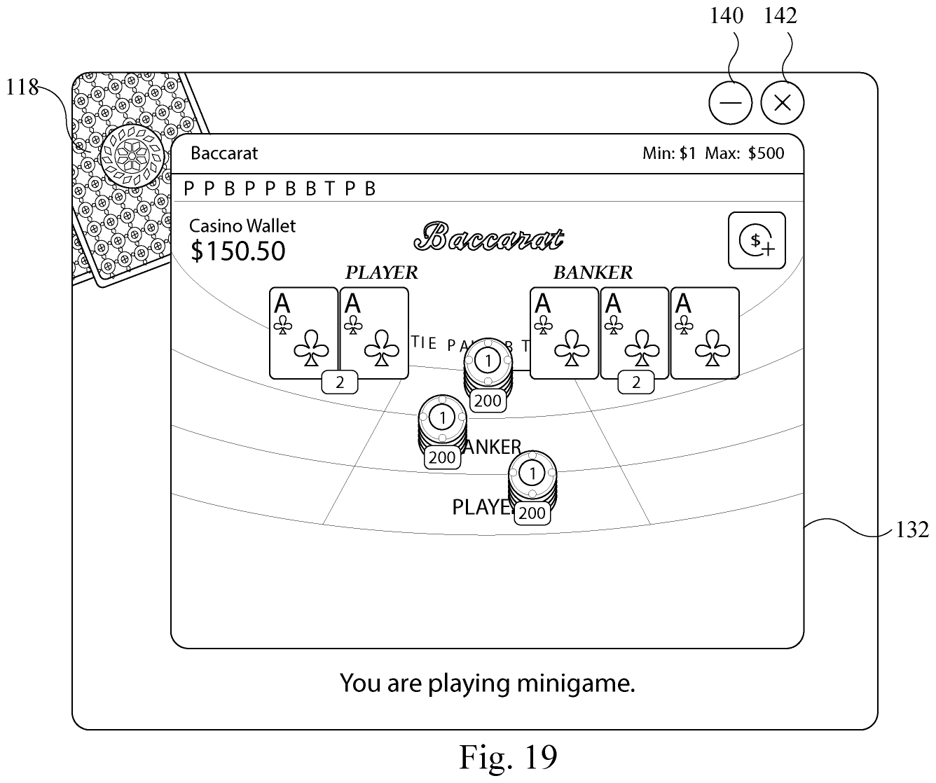

The side games are “picture in picture” games that operate independently of the community game to entertain players while they are waiting for other players to join the table or waiting for their turn during an active community game. The side games may be single player hands of blackjack (shown in FIG. 18), baccarat (shown in FIG. 19), or other casino games which players play against the house.

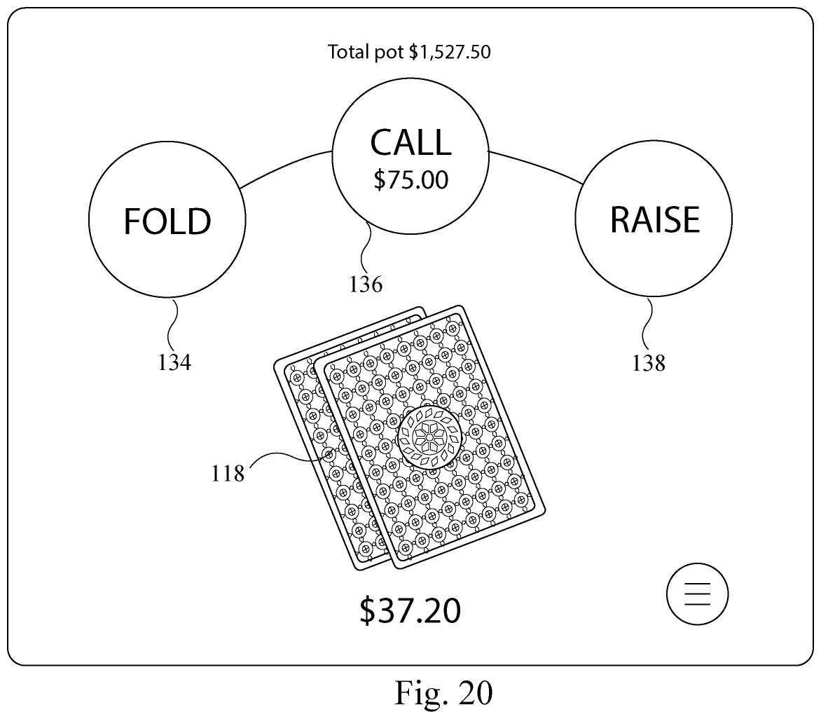

When the side game of blackjack 131 or the side game of baccarat 132 is active, the player's cards 118 temporarily fade into the background. However, when it is the player's turn to play during the active community game, the player's cards 118 automatically reappear in the foreground as shown in FIG. 20. The side games are disabled during the player's turn in the active community game until the player chooses one of the available options which, in this example, are to fold 134, call 136 or raise 138. Once the player's turn is over, the side game will reappear in the foreground and the player's cards will fade into the background again. The player may also manually minimize or exit the side game by tapping on a minimize button 140 or an exit button 142, shown in FIGS. 18 and 19. The side games allow players to utilize their time on the floor, resulting in an enhanced gaming experience.

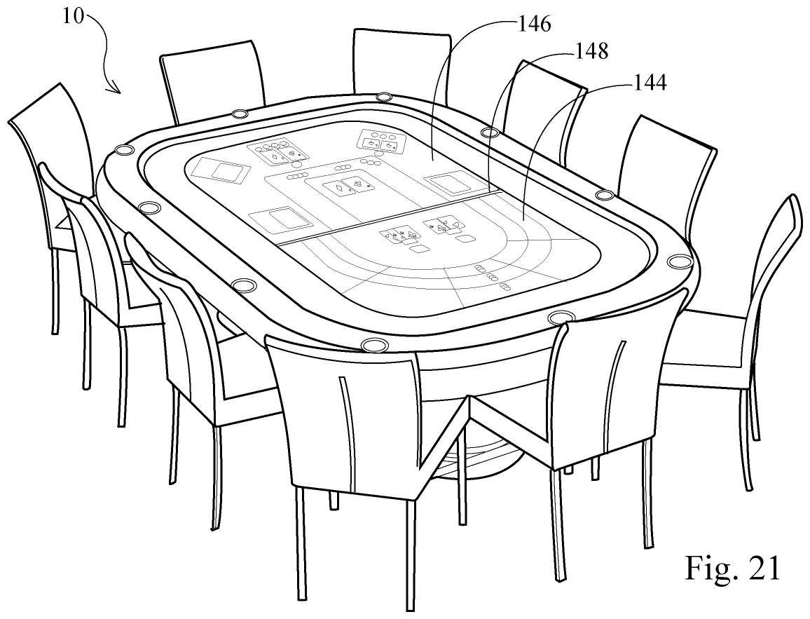

The electronic gaming table 10 may also be provided with a modular platform which allows two separate community games to be run and played simultaneously. For example, FIG. 21 shows a game of baccarat 144 activated on one half of the electronic gaming table 10 and a game of blackjack 146 activated on the other half of the electronic gaming table 10. The display on the monitor 52 is split down the middle into two images corresponding to the two games being run simultaneously. A graphic divider 148 may be used to illustrate the divide between the two games. Alternatively, different background or felt colours can be used to distinguish the two different playing surfaces or games on either side of the split. The individual player activated areas may also change depending on the type of game being played.

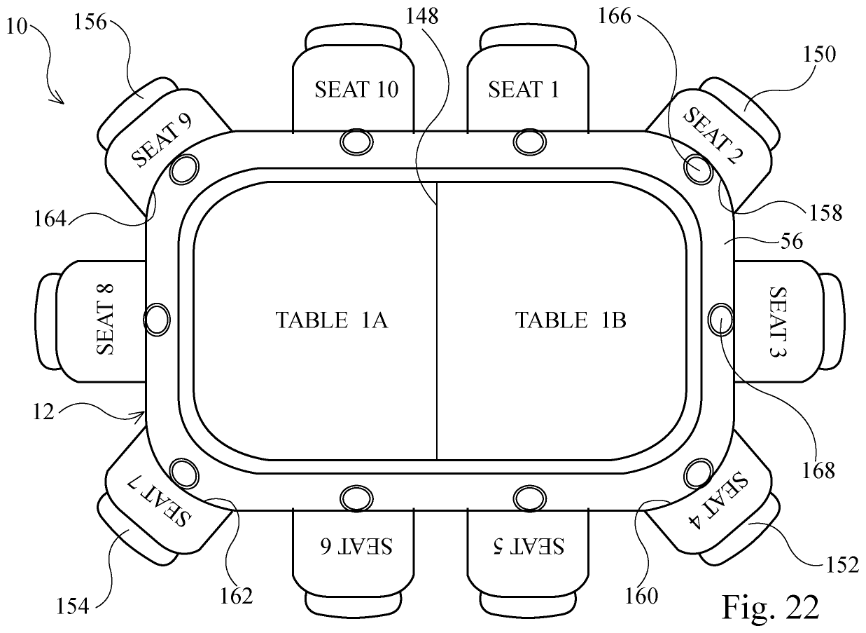

As best shown in FIG. 22, the seats may be numbered 1 to 10. Seats 1 to 5 may be identified as Table 1A and seats 6 to 10 may be identified as Table 1B. If multiple tables are used, this will expand to Table 2A and 2B, Table 3A and 3B, and etc. Game profiles are assigned to each table to run each side. In this example, Table 1A is assigned the baccarat profile while Table 1B is assigned the blackjack profile. Each game profile determines reporting metrics to the game server. Player actions and game results are tagged with the specific table and seat number to determine which portion of the table should display the respective results.

The modular platform allows the electronic gaming table 10 to be optimized based on player demand for certain games in order to reduce the number of empty seats at a table. It will be understood by a person skilled in the art that other casino games in different combinations can be activated and played on the electronic gaming table 10. It will further be understood by a person skilled in the art that the two community games may be the same type of games or different types of games.

As described above, the table top 12 has a rounded rectangular shape. Each of the rounded corners of the table top 12 has a sufficiently large radius to permit players to comfortably sit at the corners as shown by seats 150, 152, 154 and 156 at respective corners 158, 160, 162 and 164 in FIG. 22. This allows the electronic gaming table 10 to accommodate more players at a time. In this example, the electronic gaming table 10 can accommodate ten players. However, it will be understood by a person skilled in the art that the electronic gaming table 10 may accommodate fewer or more players according to the individual casino or multiplayer game displayed on the electronic gaming table 10. The edge rail 56 serves as an armrest for players and may include cup holders, for example, cup holders 166 and 168.

It will be understood by a person skilled in the art that many of the details provided above are by way of example only, and are not intended to limit the scope of the invention which is to be determined with reference to the following claims.

What is claimed is:

1. An electronic gaming table comprising:
a base;
a computer housed in the base; and
a table top mounted on the base, the table top having a frame, a monitor disposed within the frame, and a touch screen overlaying the monitor, the monitor receiving game content from the computer and the monitor displaying the game content;
wherein the monitor and the touch screen function together to provide a multi-touch playing surface for playing electronic games.

2. The electronic gaming table as claimed in claim 1, wherein the monitor and the touch screen are separated by an air gap.

3. The electronic gaming table as claimed in claim 2, wherein the air gap is up to 2.5 millimetres.

4. The electronic gaming table as claimed in any one of claims 1 to 3, wherein the touch screen includes a first layer of glass, a second layer of glass, and a touch film disposed between the first layer of glass and the second layer of glass.

5. The electronic gaming table as claimed in claim 4, wherein the first layer of glass has a thickness between 3 millimetres and 6 millimetres.

6. The electronic gaming table as claimed in claim 4, wherein the second layer of glass has a thickness between 2 millimetres and 4 millimetres.

7. The electronic gaming table as claimed in any one of claims 4 to 6, wherein at least one of the first layer of glass and the second layer of glass is made of chemically strengthened glass.

8. The electronic gaming table as claimed in any one of claims 4 to 6, wherein at least one of the first layer of glass and the second layer of glass is made of tempered glass.

9. The electronic gaming table as claimed in any one of claims 1 to 8, further including a modular platform which allows two multiplayer games to be simultaneously activated and played on the electronic gaming table.

10. The electronic gaming table as claimed in any one of claims 1 to 9, further including embedded single player side games which operate simultaneously and independently of a multiplayer game being played on the electronic gaming table.

11. The electronic gaming table as claimed in any one of claims 1 to 10, further including an edge rail having a rounded rectangular shape, the edge rail covering sharp corners of the monitor so as to create the appearance of a playing surface with rounded corners.

12. A method of providing a multi-touch playing surface for playing a game on an electronic gaming table, the method comprising:
providing a monitor and a touch screen overlaid on top of the monitor, the monitor and the touch screen being separated by an air gap;
identifying a cluster of multiple touch points on the touch screen simultaneously;
registering the touch points; and
translating the touch points into a single gesture.

13. The method as claimed in claim 12, further including providing a single player side game which operates simultaneously and independently of a multiplayer game.

14. The method as claimed in claim 13, further including disabling the side game during a player's turn in the multiplayer game.

15. The method as claimed in claim 12, further including:
activating a first multiplayer game on a first half of the playing surface;
activating a second multiplayer game on a second half of the playing surface; and
allowing the first multiplayer game and the second multiplayer game to be played simultaneously and independently of each other.

16. The method as claimed in claim 15, further including making the first multiplayer game and the second multiplayer game different types of multiplayer games.

17. The method as claimed in claim 15, further including making the first multiplayer game and the second multiplayer game the same type of multiplayer game.
